(19) United States
(12) Patent Application Publication
(10) Pub. No.: US 2004/0094864 A1
(43) Pub. Date: May 20, 2004

(54) Custom shoe sole manufacturing system

(76) Inventor: Brian J. Franzene, Lake Geneva, WI (US)

Correspondence Address: Michael S. Neustel, Suite No. 4, 2534 South University Drive, Fargo, ND, 58103, US

(21) Appl. No.: 10/299,255

(22) Filed: Nov. 18, 2002

(51) Int. Cl. B29C 33/40

(52) U.S. Cl. 264/223

(57) ABSTRACT

A custom shoe sole manufacturing system for efficiently creating a custom shoe sole. The custom shoe sole manufacturing system includes the steps of forming a negative impression of a foot within a foam member, vacuum forming a seal about the negative impression, positioning a casting frame about the negative impression, filling the casting frame with a casting material, removing the casting frame after casting material is hardened, positioning a liner upon the positive impression, securing a cover member about the casting frame, inputting a polymer into the cover member and casting frame, and removing custom shoe sole from casting frame after polymer has hardened.

### CROSS-REFERENCE TO RELATED DISCLOSURE DOCUMENT

This application incorporates subject matter contained within Disclosure Document No. 491,681 received within the U.S. Patent and Trademark Office on Mar. 30, 2001. Disclosure Document No. 491,681 is incorporated by reference into this patent application.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to shoe manufacturing processes and more specifically it relates to a custom shoe sole manufacturing system for efficiently creating a custom shoe sole.

2. Description of the Prior Art

Custom shoe manufacturing processes have been in use for years. The most common method of manufacturing custom shoes is by the usage of a “kit” containing a foam mold that the user steps into with their feet that creates a positive impression within the foam mold. The user then mails the box containing the foam mold to the manufacturer who then manufactures footwear for the consumer based upon the impression within the foam mold.

Examples of patented footwear manufacturing system which are illustrative of such prior art include U.S. Pat. No. 5,206,804; U.S. Pat. No. 5,361,133; U.S. Pat. No. 5,457,325; U.S. Pat. No. 3,696,456; and U.S. Pat. No. 5,753,931.

While these devices may be suitable for the particular purpose to which they address, they are not as suitable for efficiently creating a custom shoe sole. Conventional shoe manufacturing processes do not provide an accurate nor suitable means for creating customized shoe soles.

In these respects, the custom shoe sole manufacturing system according to the present invention substantially departs from the conventional concepts and designs of the prior art, and in so doing provides an apparatus primarily developed for the purpose of efficiently creating a custom shoe sole.

### SUMMARY OF THE INVENTION

In view of the foregoing disadvantages inherent in the known types of shoe manufacturing systems now present in the prior art, the present invention provides a new custom shoe sole manufacturing system construction wherein the same can be utilized for efficiently creating a custom shoe sole.

The general purpose of the present invention, which will be described subsequently in greater detail, is to provide a new custom shoe sole manufacturing system that has many of the advantages of the shoe sole manufacturing systems mentioned heretofore and many novel features that result in a new custom shoe sole manufacturing system which is not anticipated, rendered obvious, suggested, or even implied by any of the prior art shoe sole manufacturing devices, either alone or in any combination thereof.

To attain this, the present invention generally comprises the steps of forming a negative impression of a foot within a foam member, vacuum forming a seal about the negative impression, positioning a casting frame about the negative impression, filling the casting frame with a casting material, removing the casting frame after casting material is hardened, positioning a liner upon the positive impression, securing a cover member about the casting frame, inputting a polymer into the cover member and casting frame, and removing custom shoe sole from casting frame after polymer has hardened.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a custom shoe sole manufacturing system that will overcome the shortcomings of the prior art devices.

A second object is to provide a custom shoe sole manufacturing system for efficiently creating a custom shoe sole.

A further object is to provide a custom shoe sole manufacturing system that provides accurate custom manufactured insoles for footwear.

Another object is to provide a custom shoe sole manufacturing system that is capable of manufacturing various types of footwear such as but not limited to shoes, boots, sandals and the like.

A further object is to provide a custom shoe sole manufacturing system that reduces foot pain and related physical ailments.

Another object is to provide a custom shoe sole manufacturing system that eliminates the normal “break-in” period for footwear.

A further object is to provide a custom shoe sole manufacturing system for providing an efficient and economical system for manufacturing affordable custom footwear.

Another object is to provide a custom shoe sole manufacturing system that provides a consumer with custom manufactured footwear at an affordable cost.

An additional object is to provide a custom shoe sole manufacturing system that assists shoe sale businesses by increasing consumer satisfaction and lowering inventory costs.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention with the casting frame positioned within the foam member about the negative impression.

FIG. 2 is a top view of the present invention as illustrated in FIG. 1.

FIG. 3a is an upper perspective view of the foam member.

FIG. 3b is an upper perspective view of the foam member with a negative impression contained within the upper surface thereof.

FIG. 3c is an upper perspective view of the foam member with a seal formed about the foam member.

FIG. 4 is a lower perspective view of the casting frame.

FIG. 5 is a bottom view of the casting frame.

FIG. 6 is a cross sectional view taken along line 6-6 of FIG. 5.

FIG. 7 is an upper perspective view of the foam member surrounded by the seal with a vacuum attached to the seal.

FIG. 8 is an exploded upper perspective view of the casting frame positioned above the foam member containing a negative impression.

FIG. 9 is a cross sectional view taken along line 9-9 of FIG. 1.

FIG. 10 is an upper perspective view of the casting frame filled with casting material.

FIG. 11 is a cross sectional view taken along line 11-11 of FIG. 10.

FIG. 12 is a cross section view of an alternative embodiment wherein wax and spherical members are utilized in place of the casting material.

FIG. 13 is a side cutaway view of the casting frame being removed with the casting material contained within.

FIG. 14 is a lower perspective view of the casting frame with the positive impression contained within the hardened casting material.

FIG. 15 is an alternative embodiment of the lower perspective view of the casting frame with the positive impression contained within the hardened casting material.

FIG. 16 is a cross sectional view taken along line 16-16 of FIG. 14.

FIG. 17 is a side cutaway view of FIG. 16 with a liner positioned upon the positive impression.

FIG. 18 is a side cutaway view of the cover member attached to the casting frame in a sealed manner.

FIG. 19 is a side cutaway view with the polymer being injected into the cavity defined by the cover member and the positive impression of the casting material.

FIG. 20 is an upper perspective view of the finished shoe sole.

FIG. 21 is a cross sectional view taken along line 21-21 of FIG. 20.

### DESCRIPTION OF THE PREFERRED EMBODIMENT

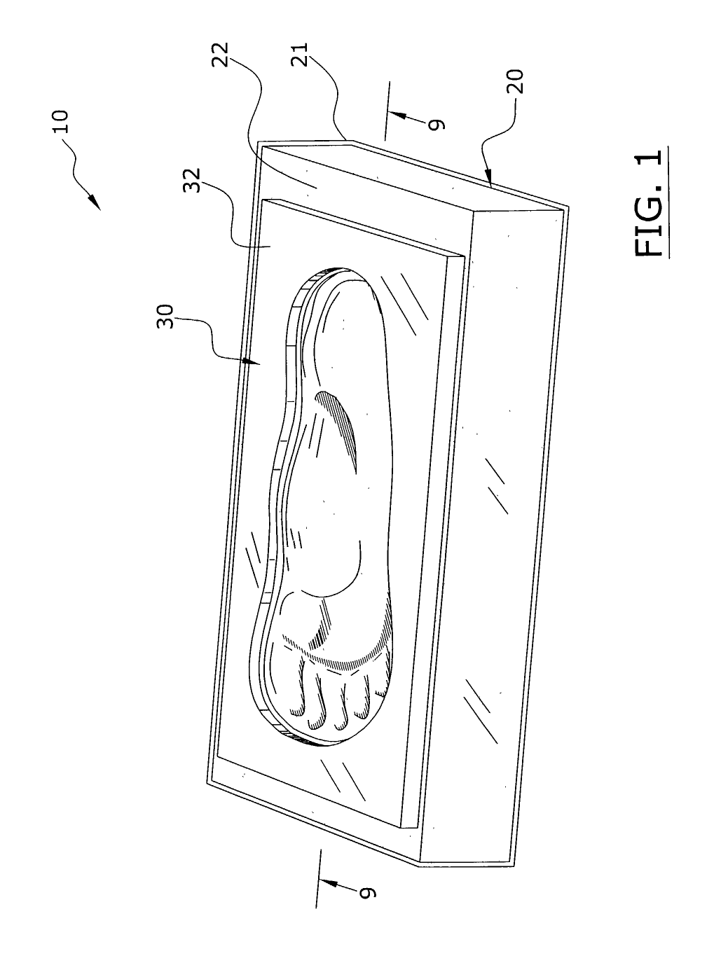

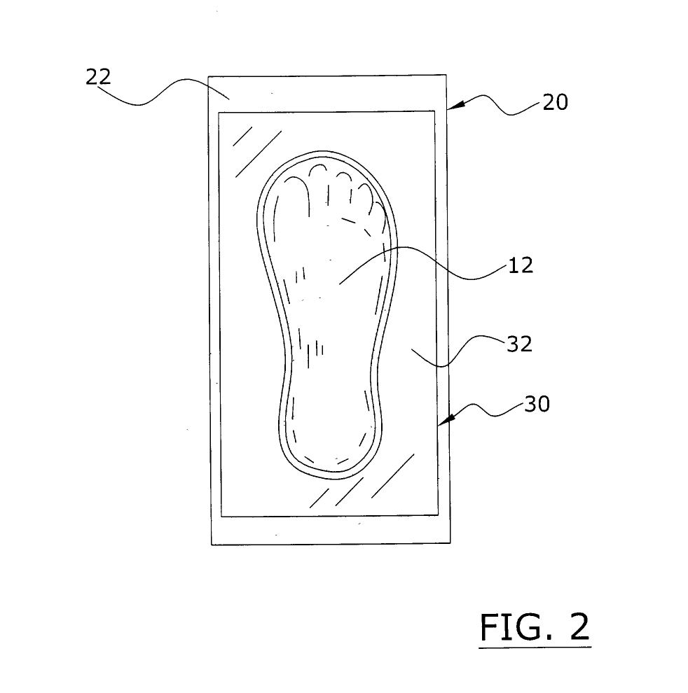

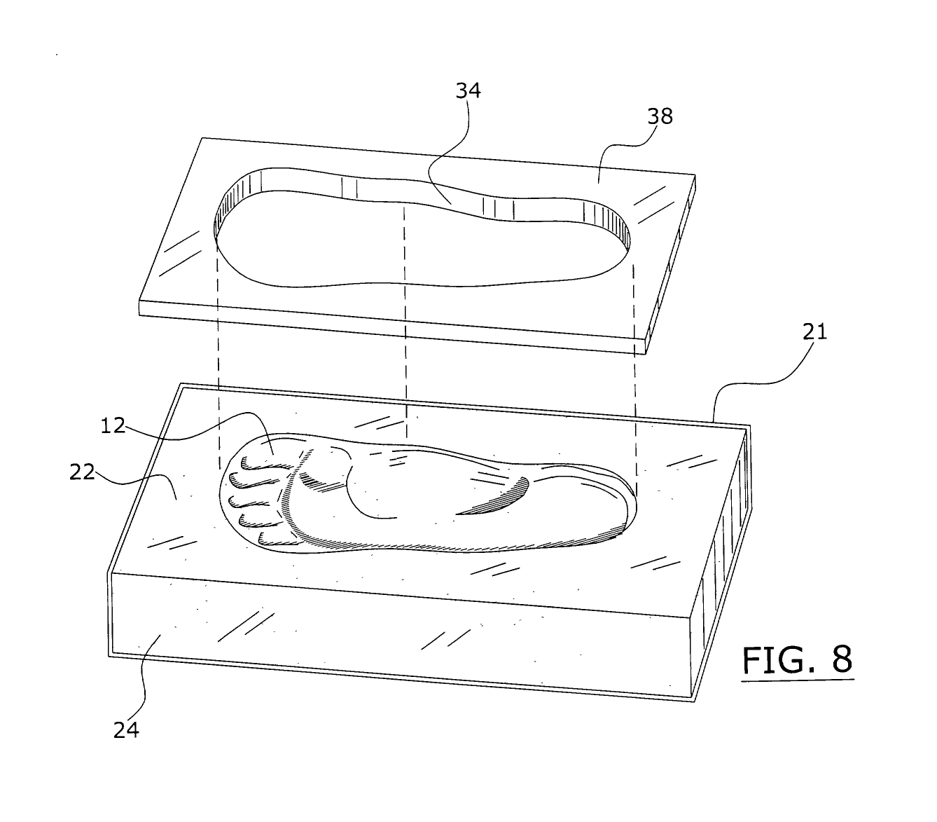

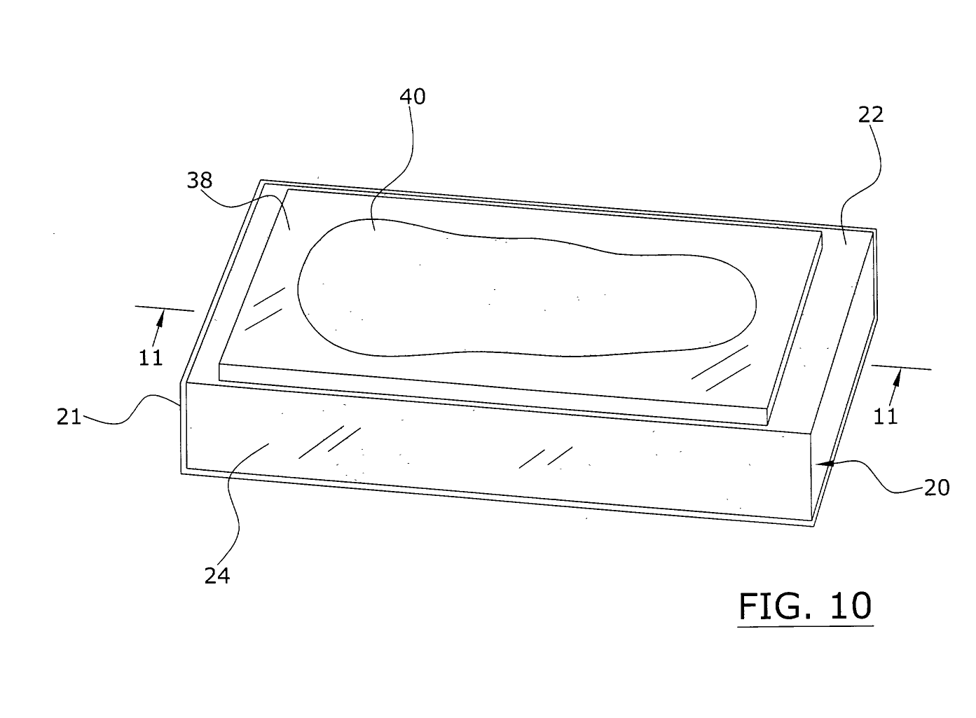

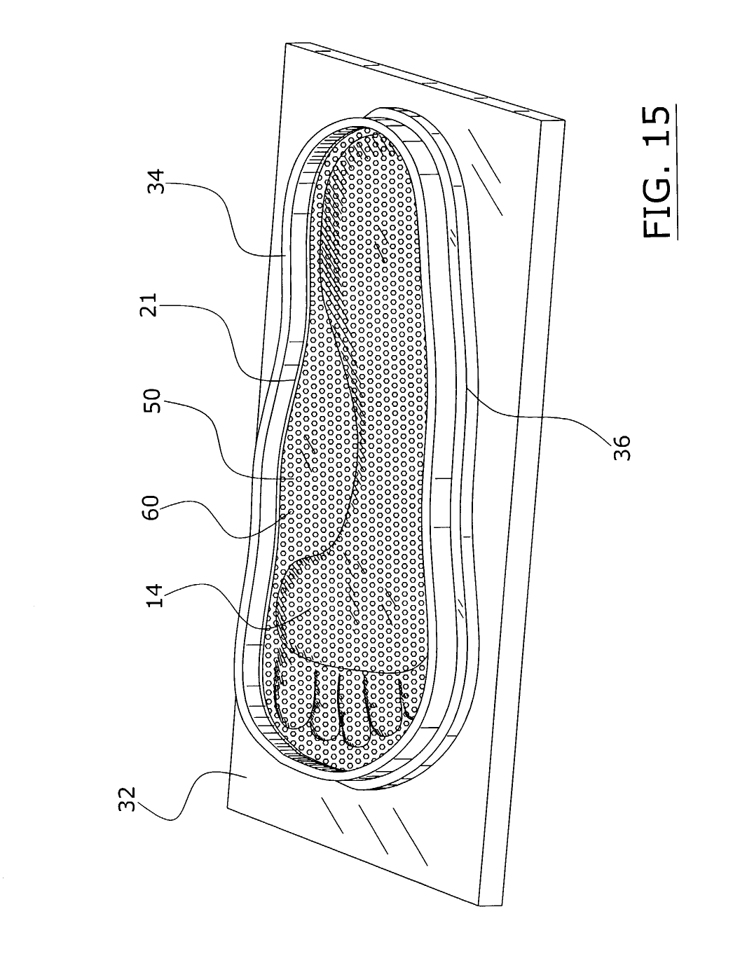

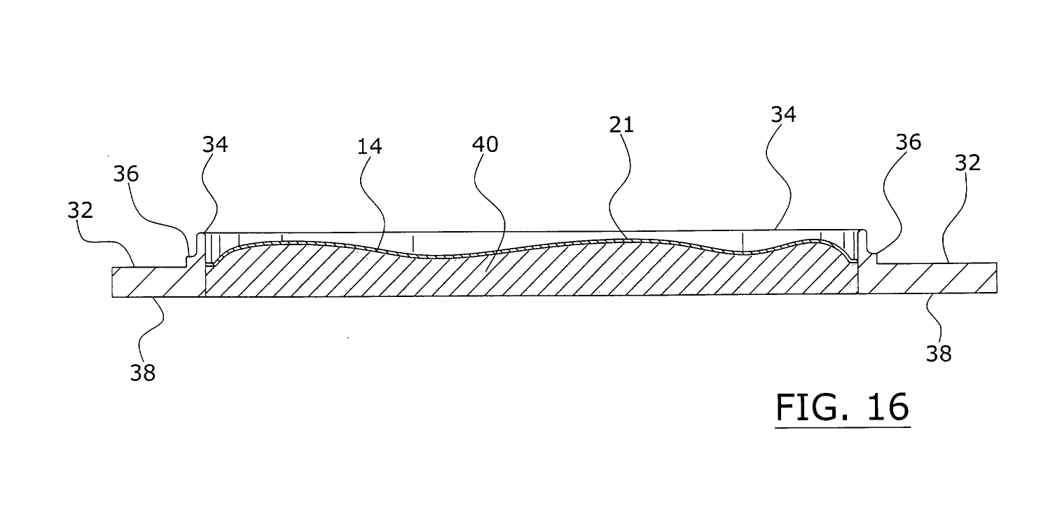

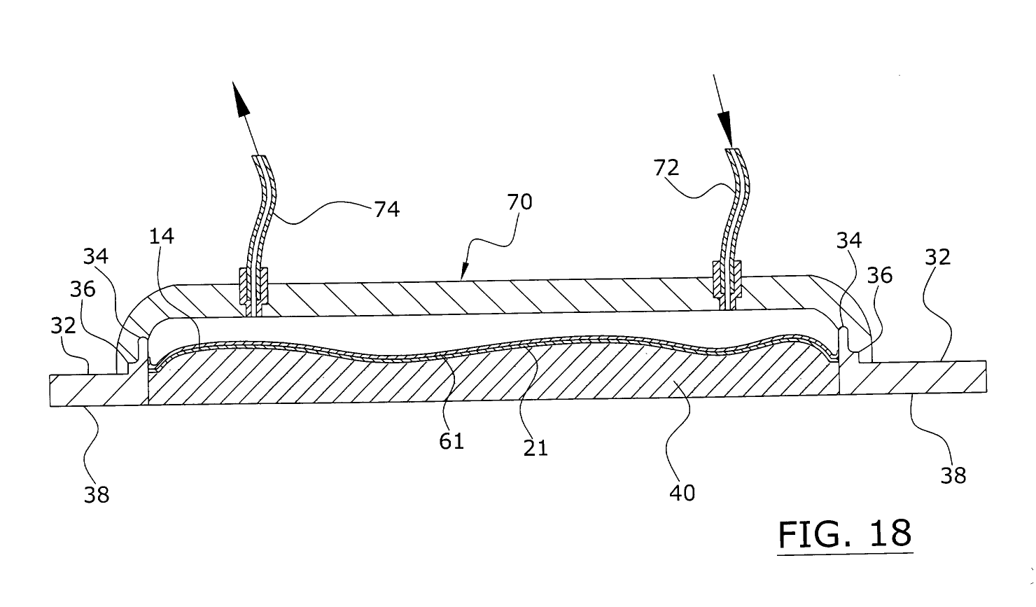

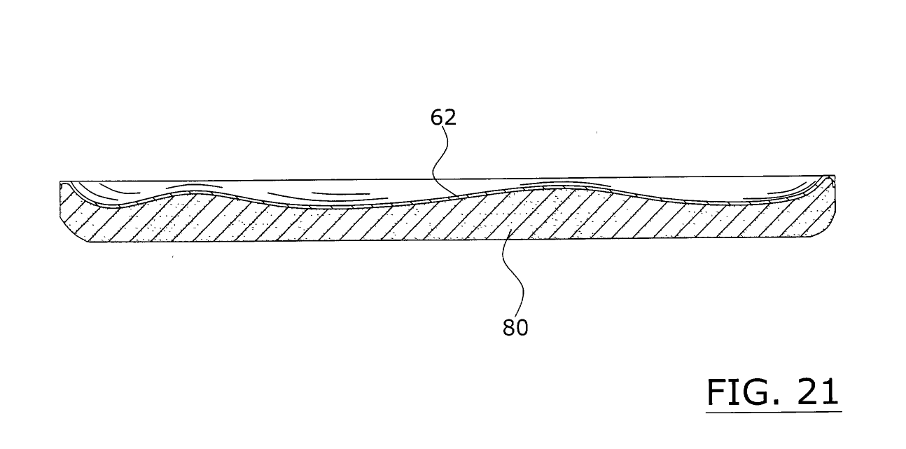

Turning now descriptively to the drawings, in which similar reference characters denote similar elements throughout the several views, FIGS. 1 through 21 illustrate a custom shoe sole manufacturing system 10, which comprises the steps of forming a negative impression 12 of a foot within a foam member 20, vacuum forming a seal 21 about the negative impression 12, positioning a casting frame 30 about the negative impression 12, filling the casting frame 30 with a casting material 40, removing the casting frame 30 after casting material 40 is hardened, positioning a liner 62 upon the positive impression 14, securing a cover member 70 about the casting frame 30, inputting a polymer 80 into the cover member 70 and casting frame 30, and removing custom shoe sole from casting frame 30 after polymer 80 has hardened.

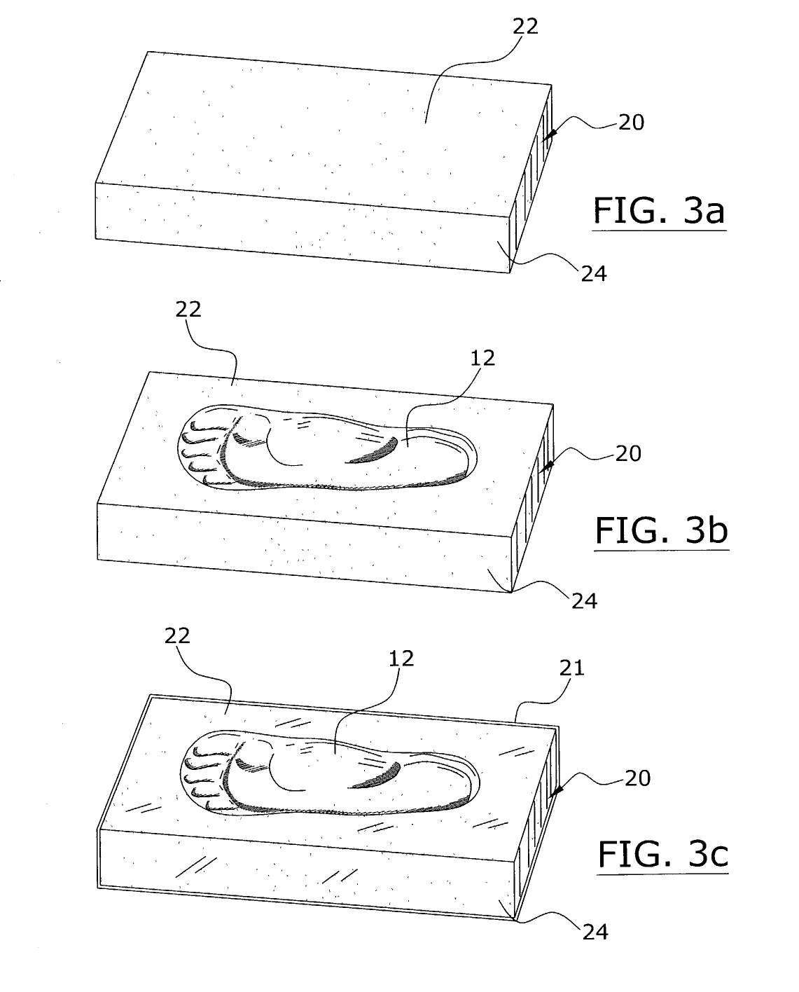

As shown in FIG. 3 of the drawings, the foam member 20 is generally comprised of a rectangular block structure of impressionable material which are commonly utilized within the custom shoe sole industry. The foam member 20 has an upper surface 22 and at least one sidewall 24. The negative impression 12 of a foot is created within the upper surface 22 of the foam member 20. It can be appreciated that the foam member 20 may have various other shapes not illustrated within the drawings.

The first step in the process is comprised of the user forming a negative impression 12 within the upper surface 22 of the foam member 20. The user simply stands upon the upper surface 22 of the foam member 20 with their foot and the negative impression 12 is created within the upper surface 22 of the foam member 20 reflecting the contour and shape of the user's foot as shown in FIG. 3b of the drawings. The amount of time required to stand upon the foam member 20 may vary depending upon the type of negative impression 12 required and the material of the foam member 20.

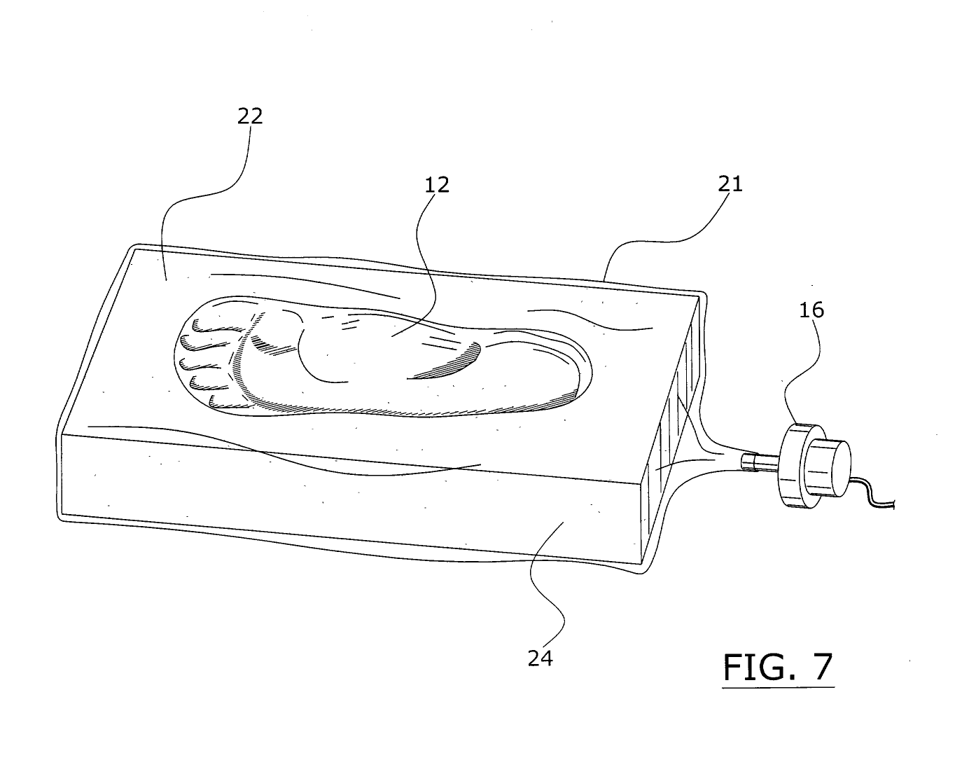

The second step in the process is positioning a seal 21 about the foam member 20 containing the negative impression 12 of the foot. The seal 21 is comprised of a thin flexible material in the form of a bag. The open end of the seal 21 is attached to a vacuum device 16 which removes the air from the seal 21 thereby drawing the seal 21 upon the outer surface of the foam member 20 including the contours of the negative impression 12 as shown in FIG. 7 of the drawings. Once the seal 21 is properly attached to the foam member 20, the user removes the vacuum device 16 and closes the open end of the seal 21 to prevent the entry of air as shown in FIG. 3c of the drawings.

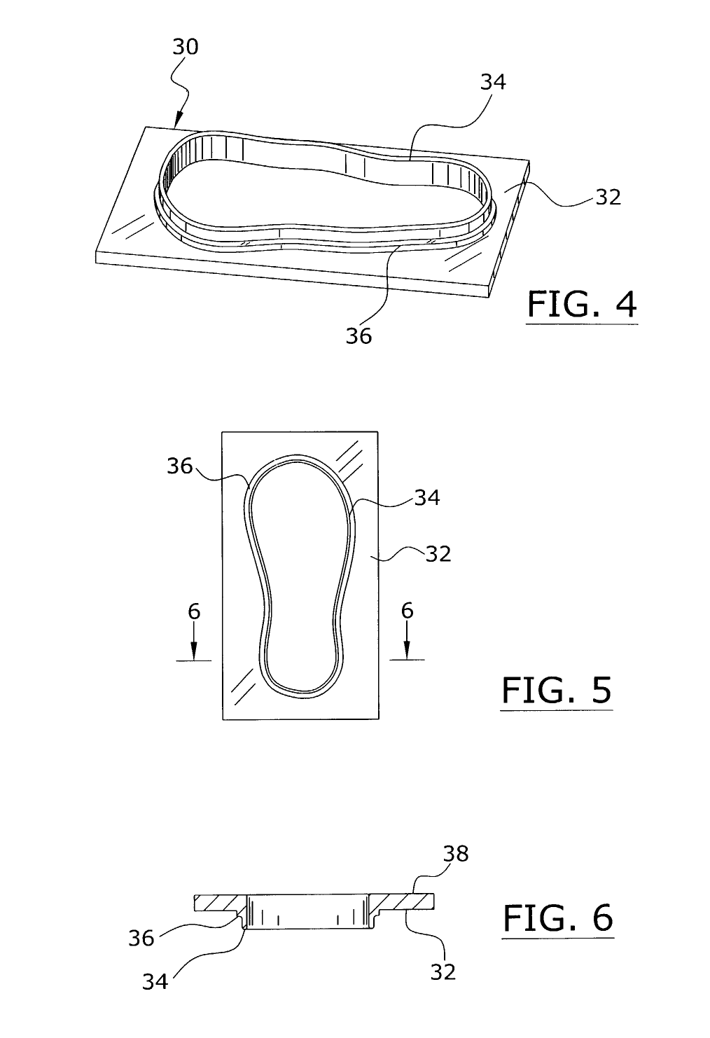

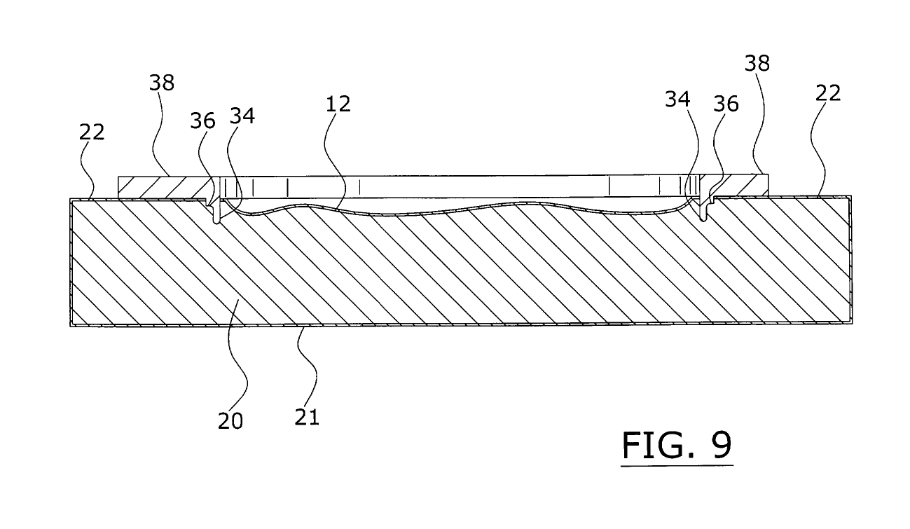

The third step in the process is the positioning of the casting frame 30 about the negative impression 12 within the foam member 20 as shown in FIGS. 1, 2 and 9 of the drawings. The casting frame 30 is comprised of a flat structure having a bottom surface 32, an upper surface 38 and an opening formed to the outer shape of a shoe sole as shown in FIGS. 4 and 5 of the drawings. The casting frame 30 further includes an inner flange 34 that extends traversely about the opening from the bottom surface 32 a finite distance as best shown in FIG. 4 of the drawings. The casting frame 30 further preferably includes an outer flange 36 that surrounds the inner flange 34, wherein the outer flange 36 has a height smaller than the height of the inner flange 34 as shown in FIG. 6 of the drawings. The inner flange 34 and the outer flange 36 penetrate the foam member 20 a finite distance as best illustrated in FIG. 9 of the drawings. The flanges 36, 38 prevent the escape of the casting material 40 poured into the casting frame 30.

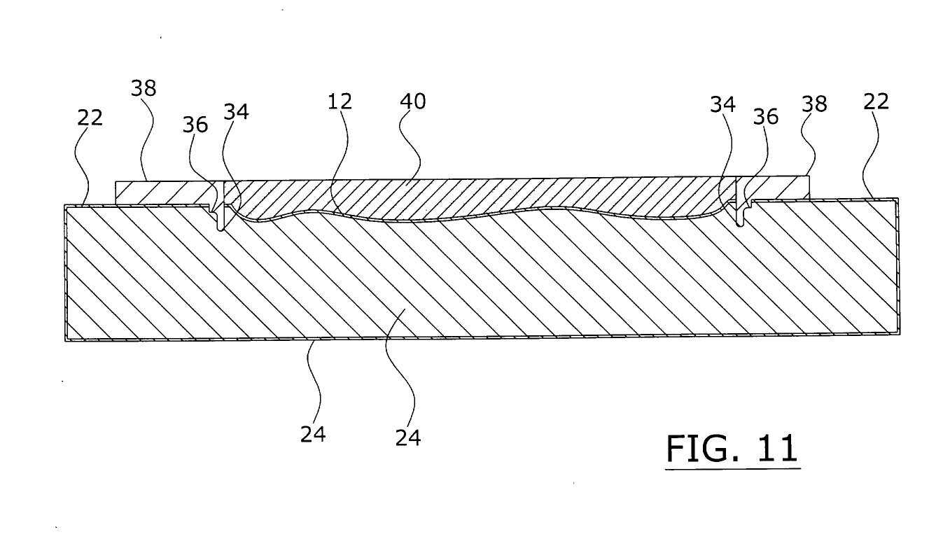

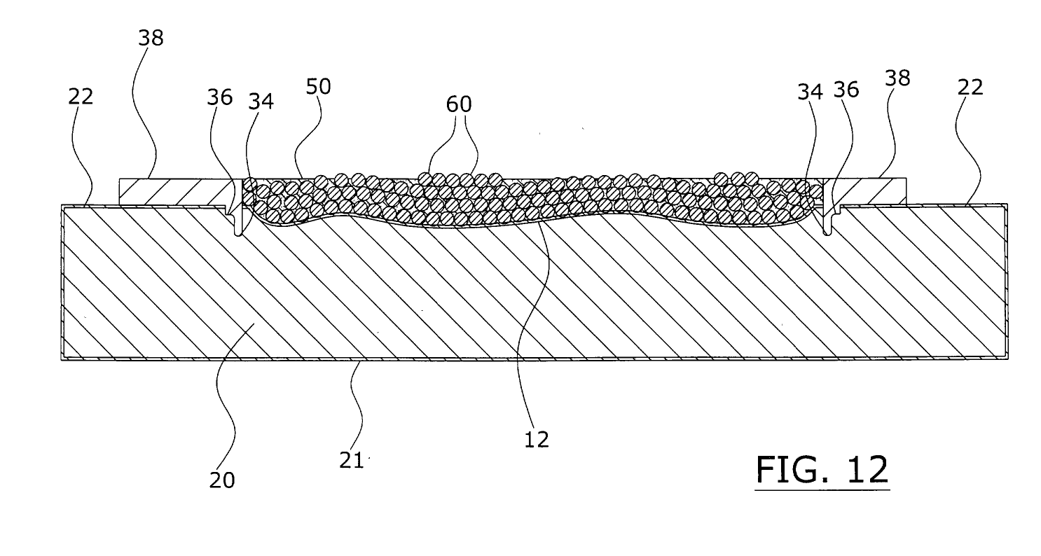

The fourth step in the process is the insertion of the liquid or semi-liquid casting material 40 into the casting frame 30 thereby forming into the negative impression 12 as shown in FIG. 11 of the drawings. The casting material 40 may be comprised of any well-known casting material 40 utilized to create a positive impression 14 from a negative impression 12. The inventor has found a useful alternative to conventional casting material 40. The inventor has found that combining liquid wax 50 and small diameter spherical members 60 together within the casting frame 30, a positive impression 14 is achieved with little distortion during the hardening of the casting material 40. The spherical members 60 are preferably comprised of a metal material such as but not limited to copper or steel. The diameter of the spherical members 60 may range between 0.5-4.0 mm. FIG. 12 illustrates the usage of the combination wax 50 and spherical members 60. The user allows the casting material 40 to harden within the casting frame 30 thereby conforming to the negative impression 12.

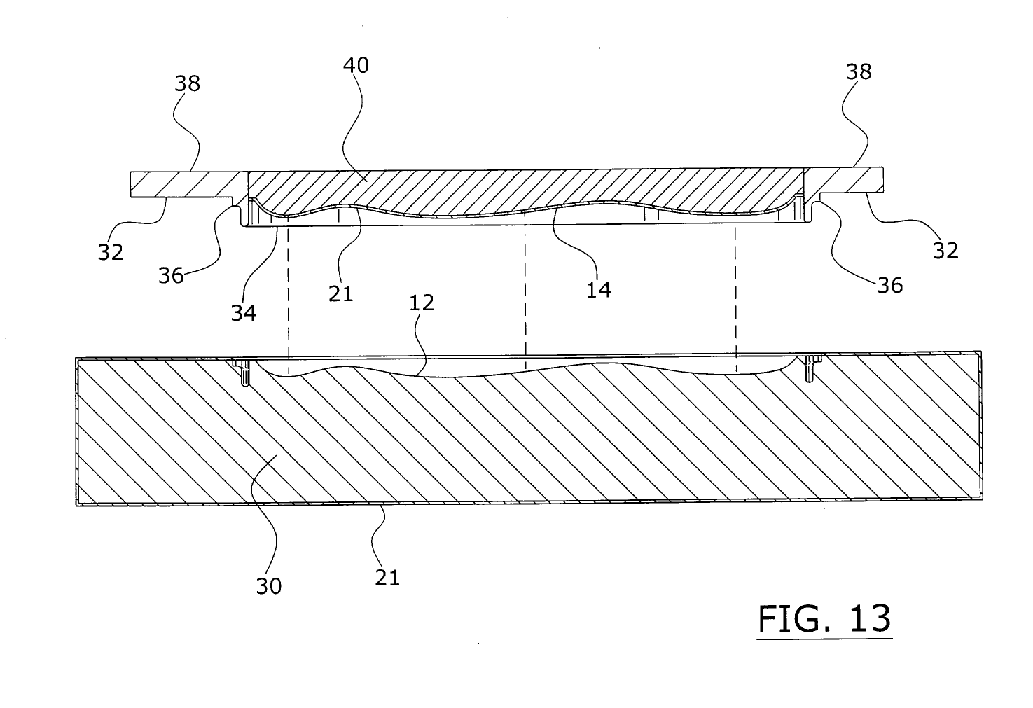

The fifth step within the process is to remove the casting frame 30 from the foam member 20 along with the hardened casting material 40 containing the positive impression 14 of the foot as shown in FIG. 13 of the drawings. The seal 21 is often times severed by the flanges 34, 36 penetrating the foam member 20 thereby a portion of the seal 21 may remain upon the positive impression 14 as shown in FIG. 13 of the drawings.

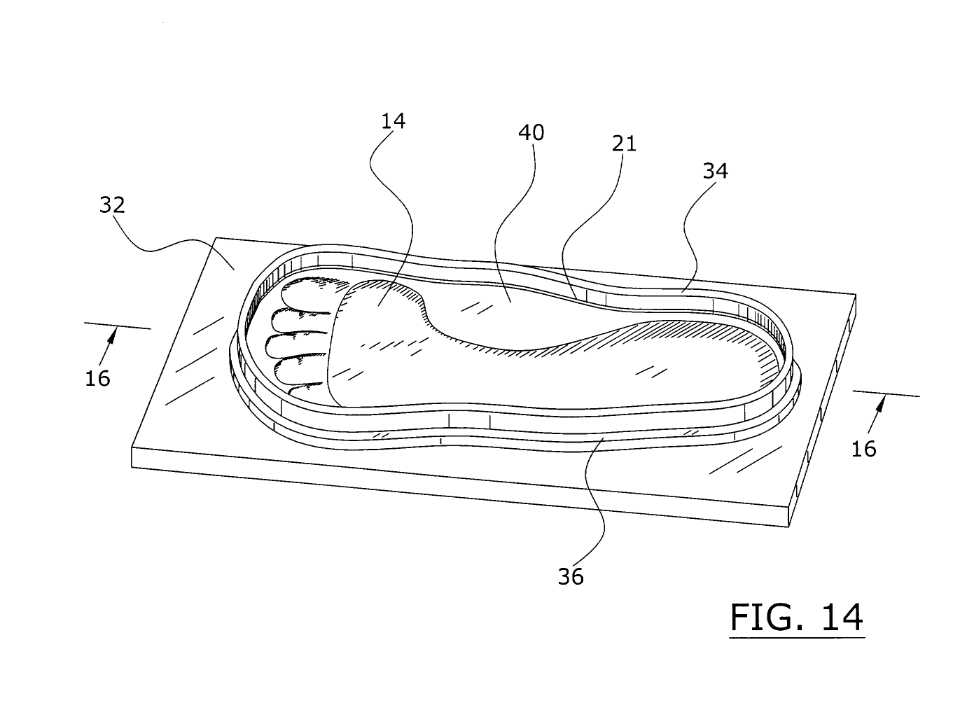

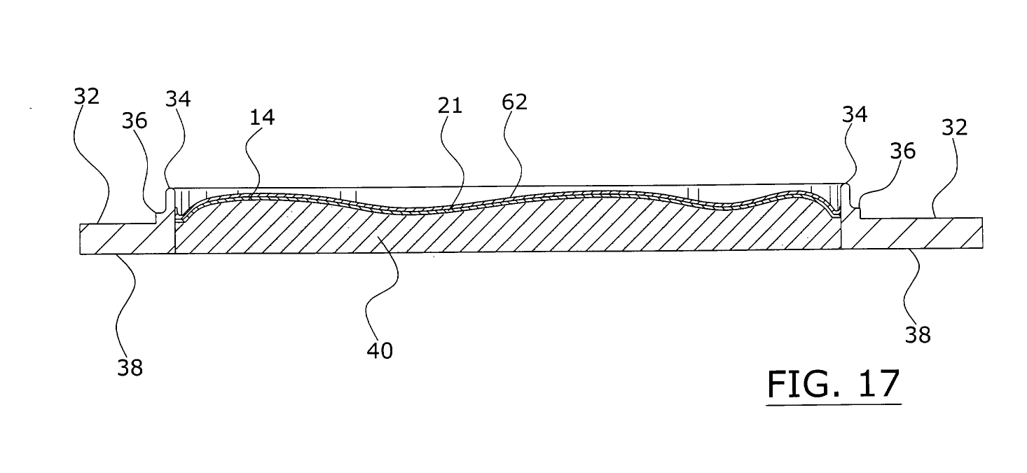

The sixth step within the process is rotating the casting frame 30 as shown in FIGS. 14, 15 and 16 of the drawings. The user then positions a liner 62, such as leather or synthetic material, upon the positive impression 14 within the casting frame 30 as shown in FIG. 17 of the drawings. The user may secure the liner 62 to the positive impression 14 with a removable adhesive to ensure that the liner 62 conforms to the shape of the of positive impression 14.

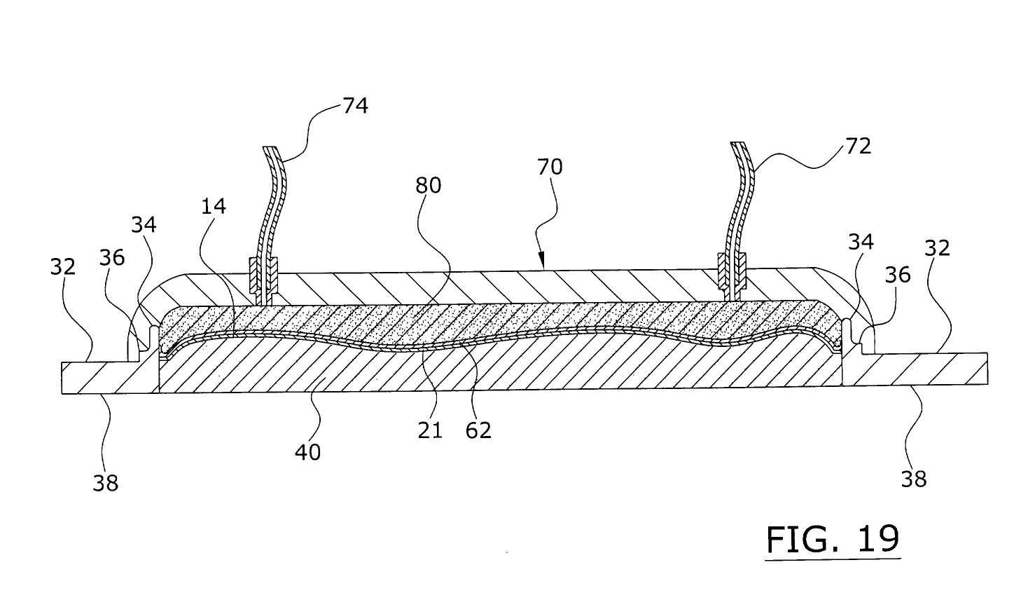

The seventh step within the process is to secure a cover member 70 about the casting frame 30 in a sealed manner thereby creating a cavity between the cover member 70 and the positive impression 14. The user then utilizes a vacuum tube 74 attached to a vacuum unit to create a vacuum within the cavity. The user then uses a fill tube 72 to input a liquid polymer 80 into the cavity until the cavity if filled as shown in FIG. 19 of the drawings. The polymer 80 is then allowed to harden within the cover member 70 and the casting frame 30 with the liner 62 being secured to the polymer 80.

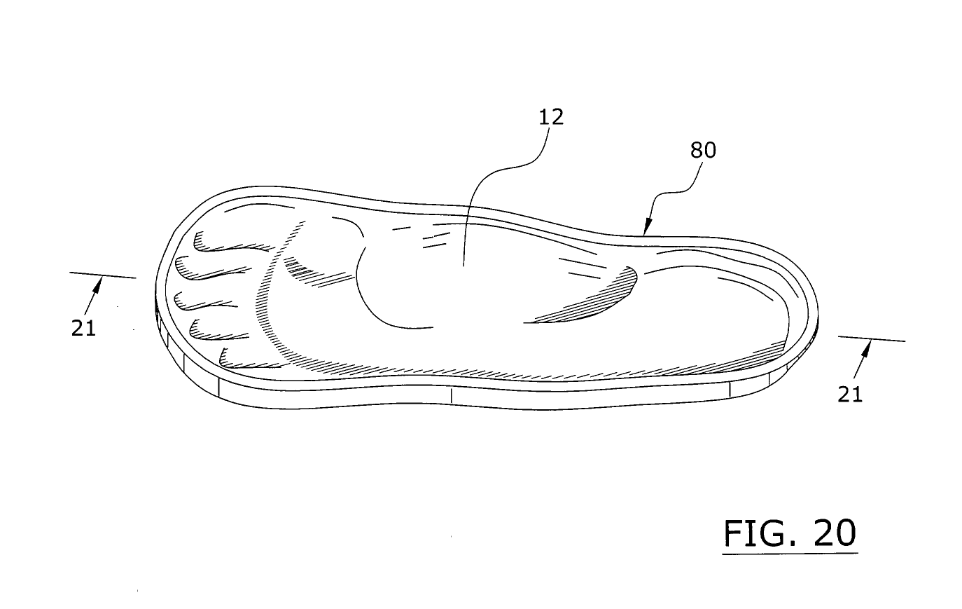

The eight step within the process is to remove the cover member 70 from the casting frame 30 and then removing the hardened polymer 80 formed into a shoe sole from the casting frame 30 as shown in FIG. 20 of the drawings. The upper portion of the shoe sole formed by the hardened polymer 80 has a negative impression 12 which reflects the shape of the foot of the user. The hardened polymer 80 shoe sole is then combined with additional materials to create a functionally shoe as desired and which are well known in the art.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of manufacturing a custom shoe sole, said method comprising the following steps:
(a) forming a negative impression of a foot within a foam member;
(b) vacuum forming a seal about said negative impression;
(c) positioning a casting frame about said negative impression;
(d) filling said casting frame with a casting material;
(e) removing said casting frame after said casting material is hardened;
(f) positioning a liner upon said positive impression;
(g) securing a cover member about said casting frame;
(h) inputting a polymer within said cover member and said casting frame; and
(i) removing said custom shoe sole from casting frame after polymer has hardened.

2. The method of manufacturing of claim 1, wherein said step of positioning said casting frame includes penetrating a flange of said casting frame into said foam member.

3. The method of manufacturing of claim 1, wherein said casting material is comprised of a combination of wax and spherical members.

4. The method of manufacturing of claim 3, wherein said spherical members have an outer diameter of between 0.5 mm to 4.0 mm.

5. The method of manufacturing of claim 4, wherein said outer diameter is 4.5 mm.

6. The method of manufacturing of claim 3, wherein said spherical members are comprised of a metal.

7. The method of manufacturing of claim 3, wherein spherical members are comprised of copper.

8. The method of manufacturing of claim 1, wherein casting frame is comprised of a flat structure having a central opening with an inner flange extending traversely from and about said central opening.

9. The method of manufacturing of claim 8, wherein said casting frame includes an outer flange surrounding said inner flange.

10. The method of manufacturing of claim 1, wherein said liner is comprised of a piece of leather.

11. A method of manufacturing a custom shoe sole, said method comprising the following steps:
(a) forming a negative impression of a foot within a foam member;
(b) vacuum forming a seal about said negative impression;
(c) positioning a casting frame about said negative impression;
(d) filling said casting frame with a casting material;
(e) removing said casting frame after said casting material is hardened forming a positive impression;
(f) applying a layer of adhesive to said positive impression;
(g) positioning a liner upon said positive impression;
(h) securing a cover member about said casting frame;
(i) inputting a polymer within said cover member and said casting frame; and
(j) removing said custom shoe sole from casting frame after polymer has hardened.

12. The method of manufacturing of claim 11, wherein said step of positioning said casting frame includes penetrating a flange of said casting frame into said foam member.

13. The method of manufacturing of claim 11, wherein said casting material is comprised of a combination of wax and spherical members.

14. The method of manufacturing of claim 13, wherein said spherical members have an outer diameter of between 4 mm to 6 mm.

15. The method of manufacturing of claim 14, wherein said outer diameter is 4.5 mm.

16. The method of manufacturing of claim 13, wherein said spherical members are comprised of a metal.

17. The method of manufacturing of claim 13, wherein spherical members are comprised of copper.

18. The method of manufacturing of claim 11, wherein casting frame is comprised of a flat structure having a central opening with an inner flange extending traversely from and about said central opening.

19. The method of manufacturing of claim 18, wherein said casting frame includes an outer flange surrounding said inner flange.

20. The method of manufacturing of claim 1, wherein said liner is comprised of a piece of leather.
